(19) United States
(12) Patent Application Publication
(10) Pub. No.: US 2020/0134067 A1
(43) Pub. Date: Apr. 30, 2020

(54) SYSTEMS AND METHODS FOR AUTOMATING A DATA ANALYTICS PLATFORM

(71) Applicant: Bouquet.ai, Inc, San Francisco, CA (US)

(72) Inventors: Joffrey Villard, Lyon (FR); Marios Anapliotis, San Francisco, CA (US); Adrien Schmidt, San Rafael, CA (US)

(21) Appl. No.: 16/177,174

(22) Filed: Oct. 31, 2018

(51) Int. Cl. G06F 17/30; G06K 9/62; G06F 17/27

(52) U.S. Cl. CPC G06F 17/30401; G06K 9/6256; G06F 17/30507; G06F 17/30554; G06F 17/2795; G06F 17/30522

(57) ABSTRACT

Systems and methods for data analytics include retrieving a first data model that includes a first set of one or more entities. A respective entity of the first set of one or more entities relates to a data subset of a first set of one or more databases, and corresponds to a metric, a dimension, or a filter. Based on the first data model, a training set is generated for training a first agent. The first agent is configured to respond to user input queries formulated in natural language. The training set for training the first agent includes a plurality of sample requests, and a plurality of database queries for the one or more databases. At least one respective database query of the plurality of database queries corresponds to at least one respective sample request of the plurality of sample requests.

### TECHNICAL FIELD

The present disclosure relates generally to systems and methods for data analytics platforms, and more specifically to automating data analytics platforms.

### BACKGROUND

Data analytics is a vital tool for many businesses and entities, allowing these organizations to quantify and summarize stored data. While automated data analytics systems have been implemented to provide data stored in a database in response to structured queries, such systems typically require users to be familiar with a specific query syntax to obtain required information. The query syntax is often complex and requires substantial time to learn and use effectively. Systems that provide previously generated queries to users in a human readable format are often inflexible as to which stored data is accessible and how the data is presented. Accordingly, there is a need for an approach to obtaining stored data that is adaptable to the needs of users.

### SUMMARY

Without limiting the scope of the appended claims, after considering this disclosure, and particularly after considering the section entitled “Detailed Description,” one will understand how the parameters of various embodiments are used to improve generation of database queries and corresponding sample requests.

The present disclosure addresses, among others, these needs in the art for systems and methods for training an agent, using a data model that comprises entities that relate to a data subset of one or more databases, to respond to natural language queries provided by a user. In this way, an agent is enabled to respond to a request (e.g., a flexibly structured natural language request for information that corresponds to stored data). For example, the agent generates a plurality of sample requests using entities (e.g., metrics, dimensions, and/or filters) stored by the one or more databases to efficiently determine sample requests (e.g., user input natural language queries) and to obtain data using database queries that correspond to the sample requests. Accordingly, in accordance with the present disclosure, a user is enabled to quickly set up an agent to enable access to a data source via natural language queries.

Accordingly, various aspects of the present disclosure provide systems and methods for training an agent. In some embodiments, a system includes a first computer system that has one or more processing units and a memory. The memory is coupled to at least one of the one or more processing units and includes one or more instructions retrieving a first data model including a first set of one or more entities. A respective entity of the first set of one or more entities relates to a data subset of a first set of one or more databases and corresponds to at least one of a metric, a dimension, or a filter. The memory further includes instructions for collecting data that is stored on the first set of one or more databases. The memory further includes instructions for generating, based on the first data model, a training set for training a first agent. The first agent is configured to respond to user input queries formulated in natural language. The training set for training the first agent includes a plurality of sample requests and a plurality of database queries for the one or more databases. At least one respective database query of the plurality of database queries corresponds to at least one respective sample request of the plurality of sample requests.

In some embodiments, the memory further includes instructions for receiving, by the first agent, from a remote user device, a user query. The user query corresponds to data on the first set of one or more databases. Additionally, in some embodiments, the memory further includes instructions for determining, by the first agent, a first sample request of the plurality of sample requests that corresponds to the user query. In some embodiments, the memory further includes instructions for transmitting, from the first agent, to the first set of one or more databases, a first database query that corresponds to the first sample request. In some embodiments, the memory further includes instructions for transmitting, to the user device, a response that corresponds to the first database query.

In some embodiments, the memory further includes instructions for altering the first data model.

In some embodiments, altering the first data model occurs in response to receiving an indication from the user device of a requested alteration to the first data model.

In some embodiments, altering the first data model includes determining, by the first computer system, a suggested alteration to the first data model. Once determined, the suggested alteration to the first data model is transmitted to the user device for display. An indication is received from the user device of a verification of the suggested alteration to the first data model.

In some embodiments, the information corresponding to the suggested alteration of the first data model includes at least a portion of the first data model.

In some embodiments, the information corresponding to the suggested alteration of the first data model includes at least a portion of the data subset of the first set of one or more databases.

In some embodiments, altering the first data model includes adding one or more relations between the domains of the first data model.

In some embodiments, altering the first data model includes modifying one or more identifiers associated with a respective entity of the first data model.

In some embodiments, modifying one or more identifiers of the respective entity of the first data model includes substituting a synonym of an identifier associated with the respective entity of the first data model for the identifier associated with the respective entity of the first data model.

In some embodiments, the synonym is selected from a list of synonyms for the one or more identifiers of the one or more entities.

In some embodiments, generating the training set for training the first agent includes generating one or more sample requests based on the altered first data model.

In some embodiments, the first data model is retrieved in accordance with a defined scope of access to the one or more databases.

In some embodiments, generating the training set for training the first agent includes generating at least one sample request of the plurality of sample requests by replacing a keyword in a template request with a respective value from a set of values of the data subset of the first set of one or more databases.

In some embodiments, the training set for training the first agent includes at least one sample request that is generated based on one or more queries received from the user device.

In some embodiments, generating the training set for the training the first agent includes accessing a query log of the user device, analyzing at least one query of the query log, and generating at least one sample request of the plurality of sample requests based on analyzing the at least one query of the query log.

In some embodiments, generating the plurality of sample requests includes replacing a keyword in a type of query of the query log.

In some embodiments, the memory further includes instructions for retrieving a second data model including a second set of one or more entities. A respective entity of the second set of one or more entities relates to a data subset of a second set of one or more databases. The memory further includes instructions for generating, based on the second data model, a training set for training a second agent. The memory further includes instructions for receiving a first user input query. The memory further includes instructions for determining, using agent selection criteria, a respective agent of a plurality of agents including the first agent and the second agent for providing a response to the first user input query.

In some embodiments, training the agent includes incorporating feedback provided by one or more users of the second computer system.

In some embodiments, training the agent includes utilizing a named-entity recognition extraction to alter an entity.

In some embodiments, a method includes, at a first computer system, retrieving a first data model including a first set of one or more entities. A respective entity of the first set of one or more entities relates to a data subset of a first set of one or more databases and corresponds to at least one of a metric, a dimension, or a filter. The method further includes generating, based on the first data model, a training set for training a first agent. The first agent is configured to respond to user input queries formulated in natural language. The training set for training the first agent includes a plurality of sample requests and a plurality of database queries for the one or more databases. At least one respective database query of the plurality of database queries corresponds to at least one respective sample request of the plurality of sample requests.

In some embodiments, a non-transitory computer readable storage medium includes one or more programs for execution by one or more processors of a computer system. The one or more programs include instructions for retrieving a first data model including a first set of one or more entities. A respective entity of the first set of one or more entities relates to a data subset of a first set of one or more databases and corresponds to at least one of a metric, a dimension, or a filter. The one or more programs further include instructions for generating, based on the first data model, a training set for training a first agent. The first agent is configured to respond to user input queries formulated in natural language. The training set for training the first agent includes a plurality of sample requests, and a plurality of database queries for the one or more databases. At least one respective database query of the plurality of database queries corresponds to at least one respective sample request of the plurality of sample requests

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 is a topology illustrating an implementation of data analytics platforms in accordance with some embodiments.

FIGS. 2A and 2B illustrate an implementation of an agent system for data analytics, in accordance with some embodiments.

FIG. 3 illustrates an implementation a database that stores data, in accordance with some embodiments.

FIG. 4 illustrates an implementation of a user device, in accordance with some embodiments.

FIGS. 5A, 5B, 5C, 5D, and 5E collectively illustrate a method for training an agent, in accordance with some embodiments.

FIG. 6 illustrates an implementation of a user interface for creating an agent skill, in accordance with some embodiments.

FIG. 7 illustrates an implementation of a user interface for reviewing and configuring one or more agent skills, in accordance with some embodiments.

FIG. 8 illustrates an implementation of a user interface for providing information related to an agent skill, in accordance with some embodiments.

FIG. 9 illustrates an implementation of a user interface for configuring an agent skill, in accordance with some embodiments.

Like reference numerals refer to corresponding parts throughout the several views of the drawings.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and parameters specifically recited in the claims. Furthermore, well-known processes, components, and materials have not been described in exhaustive detail so as not to unnecessarily obscure pertinent aspects of the embodiments described herein.

In some embodiments, systems and methods for automated data analytics platforms include retrieving a data model. The data model includes a set of one or more entities that describe an aspect of data of the data model. A respective entity of the set of one or more entities relates to a data subset of a set of one or more databases and corresponds to at least one of a metric, a dimension, or a filter of the data subset. Accordingly, a training set is generated based on the data model that is used to train a first agent. The first agent is configured to respond to a variety of user input queries that are formulated in natural language. A training set includes a plurality of sample requests and a plurality of database queries for the one or more databases of the data model. At least one of the database queries corresponds to at least one of the respective sample requests. This training set enables the agent to respond to user queries requesting information that is not expressly set forth in the one or more databases (e.g., a user query for profit in accordance with a determination that available data sales consist of sales and expenses). A sample request is, for example, a natural language user input query (e.g., a user input query of “What was is the average temperature on October 2^{nd} in California for the past two decades?”). A database query is, for example, a query run on the one or more databases to obtain the requested information (e.g., a request formatted in accordance with a query language, such as SQL).

For example, a natural language user input is received by an agent from a remote user device. The agent determines at least one database query that corresponds to the natural language user input (e.g., by determining whether the natural language user input corresponds to one or more previously generated sample requests). A database query is transmitted from the agent to the first database. The agent determines a response to the user input query based on data returned from the database in response to the database query. Training an agent (e.g., by generating a training set for use by one or more agents) based on a retrieved data model allows responses to be generated to user queries with increased efficiency (e.g., in comparison with systems that require a user to provide input for establishing each query in a set of natural language queries that may be processed by a system). Training the agent (e.g., to be responsive to particular types of queries that correspond to a particular database, set of databases, or a common set of queries for an industry) increases the efficiency with which a system responds to user queries (e.g., by producing training data that is available to the agent prior to receiving a query, in contrast to systems that must parse natural language queries and determine appropriate corresponding database queries at the time user input is received). Training an agent as described herein allows responses to natural language queries to be provided with increased speed and reduced processing.

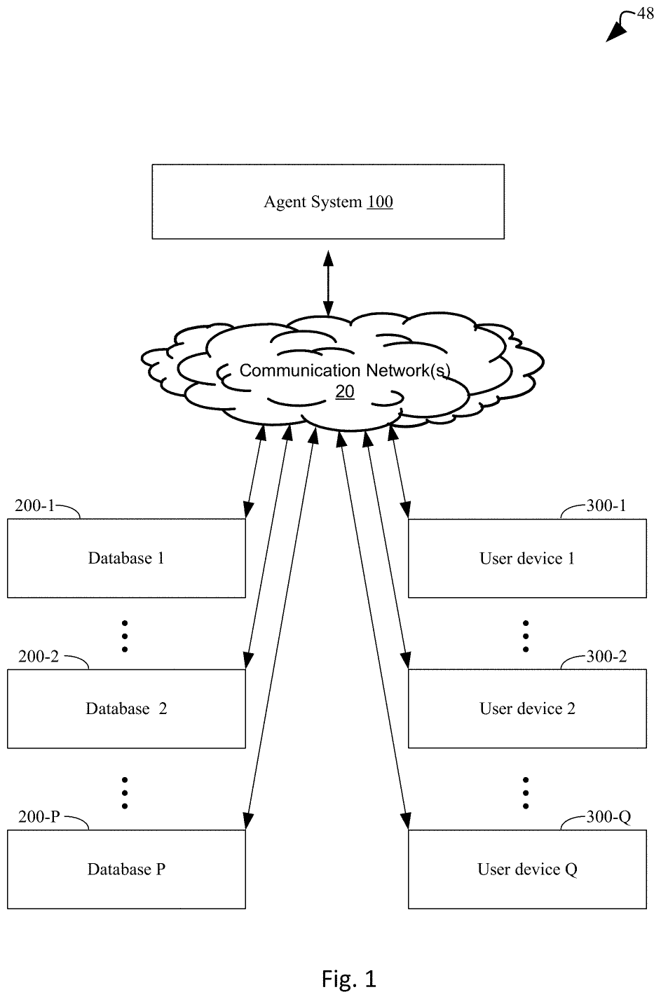

A detailed description of a system 48 for creating automated data analytics platforms in accordance with the present disclosure is described in conjunction with FIGS. 1 through 4. As such, FIGS. 1 through 4 collectively illustrate the topology of the system 48 in accordance with the present disclosure. In the figures, optional elements of embodiments are indicated by dashed boxes and/or lines. Accordingly, in the topology, there is an agent system 100 for facilitating analysis of one or more databases 200 (e.g., database 200-1, 200-2, and/or 200-3). The term “database” as used herein may refer to a single database or a set of one or more related databases. For example, in some embodiments, a respective database 200 (or a set of one or more databases), stores information and data that is associated with an entity (e.g., an organization, such as a corporation) and/or subject matter (e.g., information related to a particular industry). System 48 includes one or more user devices 300 (e.g., user device 300-1, 300-2, and/or 300-3) that are associated with a corresponding user for facilitating analysis of the data of a particular set of databases 200.

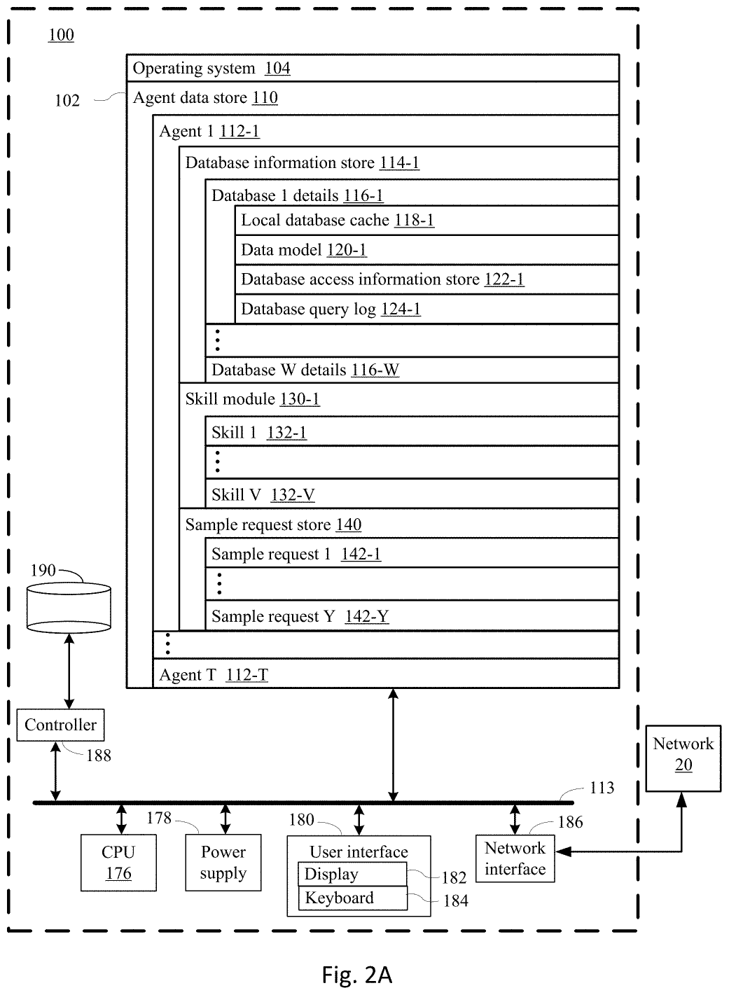

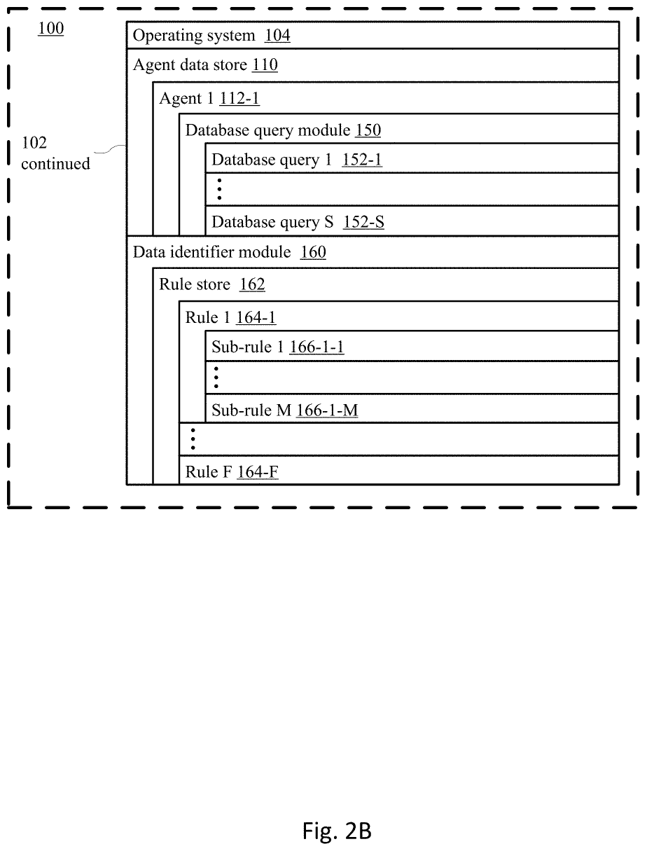

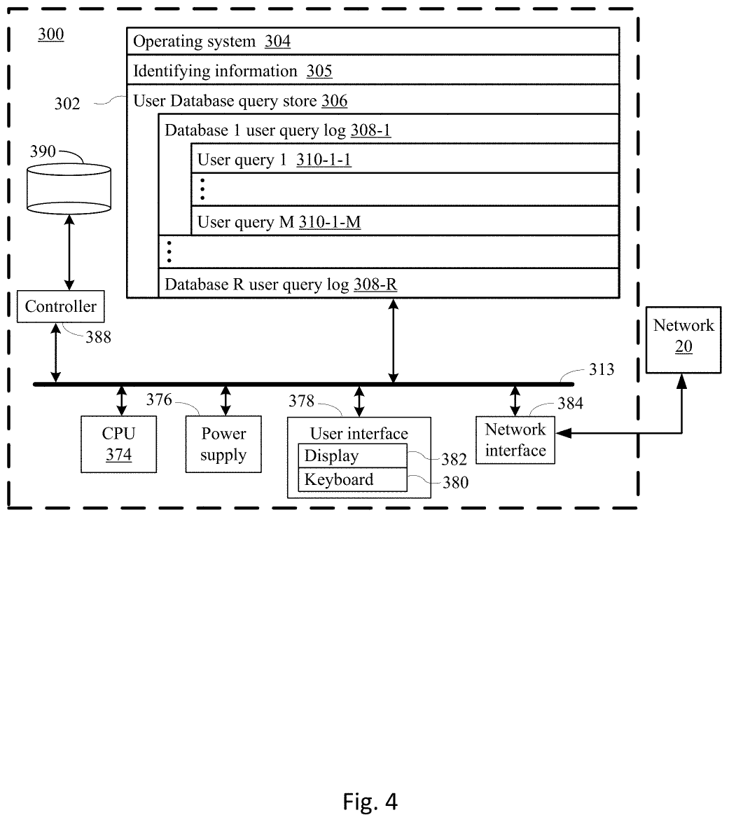

Referring to FIG. 1, the agent system 100 facilitates analyzing data that is stored on one or more databases 200. This analysis includes implementing one or more agents (e.g., agent 112-1 of FIGS. 2A and 2B), which will be described in more detail below with regard to at least FIGS. 2A and 2B). In some embodiments, an agent is trained based on information collected from one or more sets of one or more databases 200 (e.g., trained based on a retrieved data model). In some embodiments, a database 200, which is communicatively coupled with the agent system 100, is accessed by the system 48, or similarly by the respective agent, using credentials and/or an access token associated with a user (e.g., user device 300 of FIG. 4) of the respective database. In some embodiments, the agent system 100 is in direct communication with a corresponding database 200 via a communication connection (e.g., network interface 186).

It will be recognized that other topologies of the system 48 other than the one depicted in FIG. 1 are possible. In some embodiments, the agent system 100 and the corresponding databases 200 may constitute a server computer, several computers that are linked together in a network, and/or a virtual machine or a container in a cloud computing context. As such, the exemplary topology shown in FIG. 1 merely serves to describe the features of an embodiment of the present disclosure in a manner that will be readily understood to one of skill in the art.

FIGS. 2A and 2B collectively illustrate an agent system 100 for facilitating automatic data analytics, in accordance with some embodiments. Agent system 100 comprises one or more processing units (CPUs) 176, a network or communications interface 186, a memory 102 (e.g., random access memory), one or more non-volatile memory devices (e.g., magnetic disk storage and/or persistent devices) 190 optionally accessed by one or more controllers 188, one or more communications buses 113 for interconnecting the aforementioned components, and a power supply 178 for powering the aforementioned components. In some embodiments, the agent system 100 includes a user interface 180 that enables a user to manipulate the agent system. In some embodiments, the user interface 180 includes a display 182 and/or an input device 184 (e.g., a keyboard, a mouse, etc.) for use by the user. In some embodiments, data in the memory 102 is seamlessly shared with non-volatile memory 190 (e.g., using known computing techniques such as caching). In some embodiments, the memory 102 and/or memory 190 are hosted on computers that are external to the agent system 100 but that can be electronically accessed by the agent system 100 over network 20 (e.g., using network interface 186).

In some embodiments, the memory 102 of the agent system 100 for facilitating data analytics stores:
an operating system 104 that includes procedures for handling various basic system services;
an agent data store 110 that stores one or more agents 112 (e.g., 112-1, . . . , 112-T), a respective agent storing:
   a database information store 114 for storing information and/or data related to a database 116 (e.g., database 116-1, . . . , 116-W) (e.g., database details 116-1 of FIG. 2 includes information associated with database 200-1 of FIG. 1, database 2 details 116-2 of FIG. 2 includes information associated with database 200-2 of FIG. 1, etc.) including, for example:
      a local database cache 118 that replicates at least a portion of data stored by the corresponding database 200, and/or that is synchronized with the corresponding database 200 (e.g., periodically, in response to a user input, and/or based on another event that occurs during execution of an application, such as a database interface application),
      a data model 120 that is extracted (e.g., retrieved) and/or extrapolated from the corresponding database 200 (e.g., a schema for the corresponding database 200),
      database access information store 122 that stores information pertaining to access of the corresponding database, such as an access key, a token, and/or a password associated with the corresponding database 200, and
      a database query log 124 that stores a general record of queries of the corresponding database 200;
   a skill module 130 for storing one or more skills 132 (e.g., skill 132-1, . . . , 132-V) of the corresponding database 200 that provide one or more predetermined alterations to various entities associated with and/or based on data that is stored on the corresponding database, (e.g., used to generated generate sample requests 142);
   a sample request store 140 that stores one or more sample requests 142 (e.g., sample request 142-1, . . . , 142-Y) that correlate to and/or are used to predict one or more user queries (e.g., a sample request based on data of the corresponding database 200); and
   a database query module 150 that stores one or more database queries 152 (e.g., database query 152-1, . . . , 152-V) (e.g., that correspond to a respective sample request and/or that are used to query corresponding database 200); and
a data identifier module 160 that assists in analyzing data and information stored in database 200 (e.g., identifying one or more entities of the data model, retrieving a data model 120, etc.), the data identifier module 160 storing a rule store 162 that has one or more rules 164 for identifying data and/or identities related to data stored in a database.

As described above, the agent system 100 includes one or more agents 112. For example, in some embodiments, an agent 112 is associated with (e.g., trained for) a respective database 200 or set of databases (e.g., collects data from and/or generates one or more sample requests (e.g., sample requests 142) and/or database queries (e.g., database query 152) for the respective databases). In some embodiments, a first agent 112-1 is trained based on data associated with a first database 200 (e.g., a first data model). In some embodiments, a first agent 112-1 is trained based on data associated with a first database (e.g., 200-1) and is also trained based on data associated with a second database (e.g., 200-2) (e.g., a first agent 112-1 is trained based on a first training set of a first data model 120-1 and a second training set of a second data model 120-2). In some embodiments, a first agent 112-1 is trained based on data associated with a first database (e.g., 200-1) and a second agent 112-2 is trained based on data associated with a second database (e.g., 200-2) (e.g., an agent is trained independently). In some embodiments, an agent (e.g., agent 112-1) is a chat-bot accessible to a user through the Internet (e.g., via an application executed by an Internet browser running on a user device and/or an application executed by the user device, such as an instant messaging application or dedicated query application). For example, in some embodiments, the agent provides automated responses to user input queries. Agent 112 converses with users (e.g., using natural language queries and responses). For example, an agent 112 receives a request for information from a user and transmits a result of the request (e.g., a result of a database query) to the user (e.g., by displaying the result at a user device associated with the respective user). In some embodiments, the agent system 100 generates training sets for training respective agents. A training set includes one or more sample requests 142 (e.g., natural language query sentences) based on data model 120. Agent system 100 is trained to generate one or more database queries 152 that correspond to the generated sample requests 142. In some embodiments, a respective agent 112 is associated with a particular subject matter (e.g., a particular database, a particular industry, a particular organization, etc.) in order to make information accessible to users through commonly performed searches and/or common expressions used by members of the particular organization and/or industry. For instance, in some embodiments, an agent is associated with a travel industry and becomes an expert and responding to sample requests related to the travel industry.

Agent 112 includes a database information store 114 that stores data and/or information (e.g., database details 116) related to database 200 that is associated with the corresponding agent. In some embodiments, this data and/or information of the database details 116 include the local database cache 118, which replicates at least a portion of data stored by the corresponding database 200. In some embodiments, this data and/or information of the database details 116 also include the data model 120, which is, for example, a schema or other representation of the corresponding database 200. In some embodiments, the data model 120 includes entities 210 of the data stored on the corresponding database 200 (e.g., as explained below in more detail). In some embodiments, data model 120 includes, for example, tables, foreign keys, etc. that indicate a structure of the data in the database 200 and/or one or more relations between tables of the database. In some embodiments, a data model 120 is converted into a multidimensional data model and stored by the agent system 100. In some embodiments, the data model 120 is collected and/or identified using one or more rules (e.g., rules 164 of FIG. 2, which will be described in more detail below).

In some embodiments, and as described above, agent 112 is associated with a set of one or more databases. In some embodiments, a set of databases is formed according to a subject matter of the databases (e.g., databases associated with the travel industry form a first set of databases). In some embodiments, a set of databases is formed according to ownership and/or access to the respective databases (e.g., databases owned by a particular company form a set of databases). In some embodiments, a set of databases is formed according to a user definition (e.g., a user selects which databases form a particular set). Accordingly, in some embodiments, a first agent 112-1 creates and/or identifies a first data model 120 that corresponds to a first set of one or more databases 200. In some embodiments, the first data model 120-1 and/or a first training set generated using the first data model is applied to a second agent 112-2 that is associated with a second set of one or more databases 200, which allows for the second agent to benefit from information already gained through the first training set. In some embodiments, the second agent 112-2 (e.g., trained using the first data model 120-1 and/or a first set of training data generated using the first data model) creates and/or identifies a second data model 120-2 and/or a second training set using the second data model that correspond to a second set of one or more databases 200.

In some embodiments, agent 112 includes database access information 122 that enables the respective agent to access corresponding databases 200 (e.g., by providing credentials and privileges). In some embodiments, the database access information 122 is provided by a respective user of the corresponding database 200, and/or accessed through data stored in the corresponding database. In some embodiments, the database access information 122 includes a username and/or password associated with the corresponding database 200. For example, the user name and/or password is associated with a database 200 in a database management system (e.g., Postgres, MySQL, Greenplum, etc.). In some embodiments, the database access information 122 includes an access token and a refresh token that are collected from the corresponding database 200 (e.g., an API-based server such as Jira or SFDC). In some embodiments, use of these tokens require an authorization process (e.g., OAuth 2, etc.). In some embodiments, the database access information 122 includes user information and/or information about user access rights (e.g., control access to the corresponding database 200). The database access information 112 allows agent 112 to access respective databases 200 without human intervention in accordance with a determination that a user has provided proper credentials.

In some embodiments, the database details 116 include database query log 128 (e.g., a record of queries provided to the corresponding database 200). In some embodiments, the queries of the database query log 128 include one or more queries that were communicated from various user devices 300 to the corresponding database 200. In some embodiments, the database query log 128 is analyzed by the agent 112 for generating and/or augmenting a training set (e.g., for generation of one or more sample requests 142 and/or database queries). For example, in some embodiments, a database query log 128 is accessed by the agent 112 to identify and/or extrapolate one or more entities of the data model associated with the database.

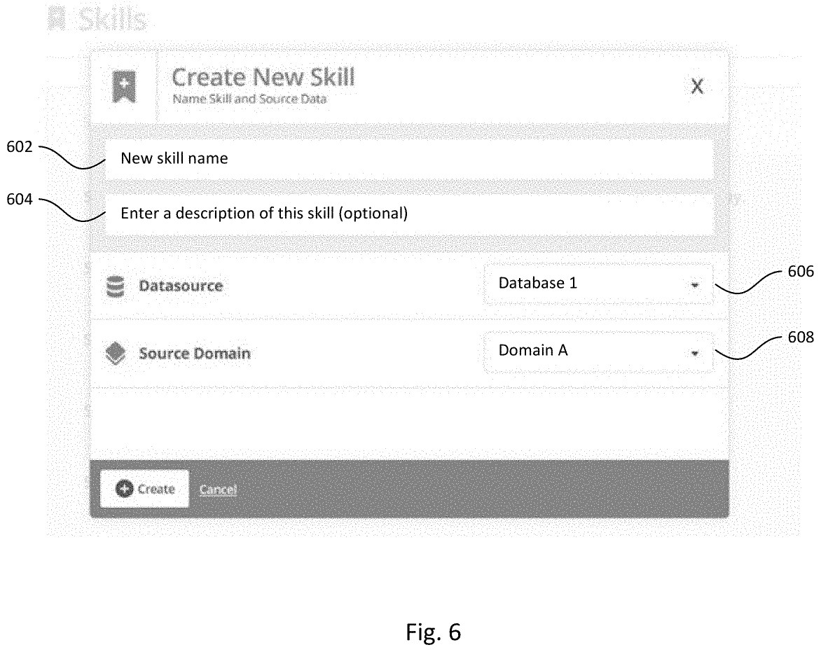

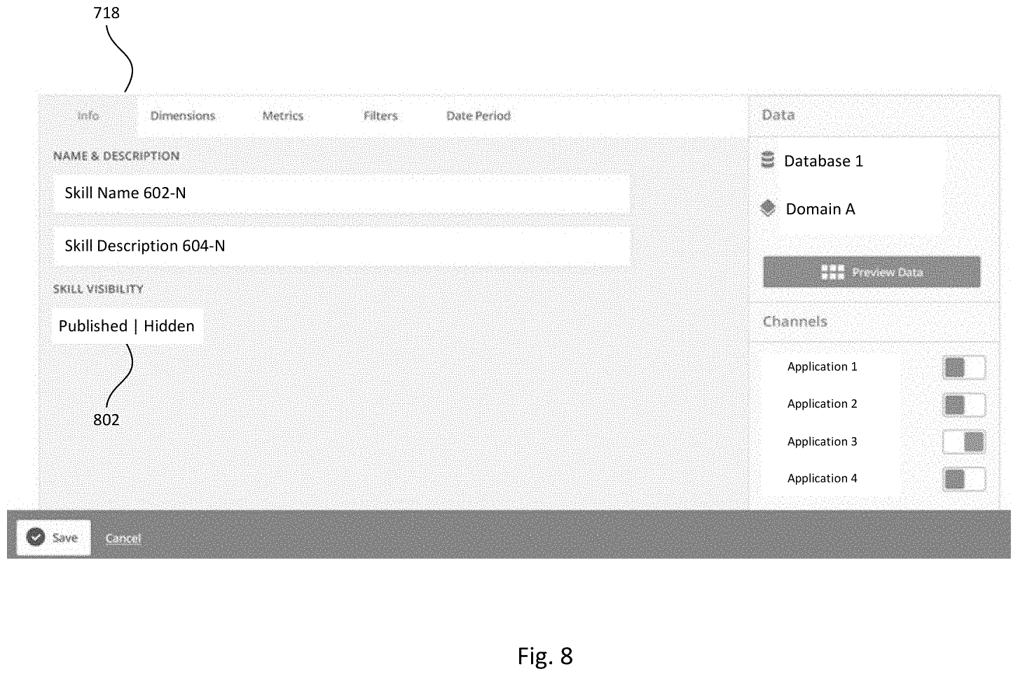

In some embodiments, the agent 112 includes a skill module 130, which stores one or more skills 132 (e.g., a trained skill of the agent 112). In some embodiments, a skill 132 corresponds to the data model 120 of the database 200. For example, in some embodiments, a skill 132 includes a defined set of one or more entities (e.g., domains, metrics (e.g., quantifiable numbers such as revenue, a number of transactions or sales count, a number of tickets, a commission earned, a number of events, etc.), and/or filters), dimensions (e.g., a column of a table of a database and/or a result or set of results of an operation performed on one or more elements of a table), and/or synonyms. In some embodiments, the skills 132 are used to generate one or more sample requests 142. For example, in some embodiments, the skills 132 include the above described metrics (e.g., revenue as a metric). Accordingly, in some embodiments, one or more sample requests 142 is generated to account for each permutation of request that includes revenue as a metric (e.g., “What is the revenue for @dimension?” generates sample request permutations for “What is the revenue for our biggest buyer?”, “What is the revenue for that buyer in California, Oregon, and Washington?”, etc.). The skills 132 enable the agent 112 to determine sample requests 142 based on predetermined actions that are created by a user device 300 and/or the agent 112, such as the bookmark of the database 200 (e.g., filters and/or data alterations defined in the bookmark). For example, in some embodiments, the skills 132 provide alterations to the data model 120. In some embodiments, one or more skills 132 are created and/or altered by a user of the system (e.g., via input at a respective user device 300 as described below with reference to at least FIG. 6 through FIG. 9), created by the agent system 100 (e.g., are predetermined skills), or a combination thereof. In some embodiments, a skill 132 is generated by determining a synonym for an identifier of an element (e.g., a column) of a data model 120 and replacing and/or suggesting a replacement of the identifier with the synonym. In some embodiments, a respective skill is an aggregation of and/or an operation performed on one or more entities of the respective data model 120. For example, a respective skill is a domain of the database that is determined using an operation performed on data from multiple columns of the database, such as CASE(‘has_accessory’=true && ‘Product Category’=“Bag”), which operates on data in ‘has_accessory’ and ‘Product Category’ columns in a database and may return different results depending on whether the requirements of the CASE statement are satisfied. In some embodiments, a skill 132 is shared between two or more agents 112 (e.g., a first agent 112-1 and a second agent 112-2 have access to a first skill 132-1).

In some embodiments, agent 112 includes sample request store 140 that stores one or more sample requests 142. In some embodiments, sample requests 142 are based on information from the data model 120 and/or the data of the database 200. For example, in some embodiments, a sample request 142-1 is based on one or more names of data fields (e.g., “What is X of Y,” such that all permutations of inputs of for data field X and/or data field Y are considered by the sample request 142-1). In some embodiments, a sample request 142 is a natural language query sentence (e.g., “What was our profit for beer in the third quarter?”). In some embodiments, a sample request 142 is associated with one or more other sample requests. For example, in some embodiments, if a sample request 142 describes “What is @metric for @dimension_1?”, an associated sample request describes “How about in @dimension_2?”. This allows for the user to communicate with agent 112 as if holding a natural conversation, instead of needing to input a full search request (e.g., instead of “How about in @dimension_2?”, the user inputs “What is @metric for @dimension_2?”). In some embodiments, the sample requests 142 are used to train a corresponding agent 112 based on a particular database and/or set of databases. Training is accomplished by generating sample requests 142 that are interpolated for use in another database 200 and/or set of databases.

The agent 112 also includes the database query module 150, which includes one or more database queries 152. A database query 152 is a structured query for requesting information and/or data from a database 200. For example, a sample request 142 is a natural language sentence (e.g., “Who are the employees in the San Francisco office?”) and the corresponding database query is a data construct in a query language (e.g., SELECT*FROM Employees WHERE City=‘San Francisco’). In some embodiments, a database query 152 corresponds to one or more sample requests 142. For example, multiple sample requests (e.g., “Who are the employees in the San Francisco office?” and “Who are the staff in the San Francisco office?”) correspond to a single database query (e.g., SELECT*FROM Employees WHERE City=‘San Francisco’). In some embodiments, a sample request 142 corresponds to one or more database queries 152. In some embodiments, the database query module 150 stores one or more queries that are extracted and/or extrapolated from the database query log 124. In some embodiments, the database query module 150 stores one or more database queries 152 that are extracted and/or extrapolated from the corresponding database query log 128, from another database query log (e.g., a second database in a set of databases associated with the corresponding database), from one or more user devices 300, or a combination thereof.

In some embodiments, the agent 112 includes a data identifier module 160, which stores one or more rules 164. In some embodiments, one or more rules 164 include at least one sub-rule 166. For example, a rule 164 instructs an agent 112 to determine a gross profit from provided revenue and expense data fields (e.g., gross profit is revenue minus expense) and a sub-rule 166 of this rule includes an instruction to extrapolate a gross profit margin (e.g., gross profit margin is a ratio of gross profit to revenue). These rules 164, and optional sub-rules 166, are used by the agent 112 to identify and/or calculate various parameters of the set of one or more databases 200 that are associated with the agent. In some embodiments, a second agent 112-2 includes one or more rules 164 that are based on rules generated for a first agent 112-1. In some embodiments, rules 164 include predetermined operations for retrieving tables, foreign keys, and/or other parameters of the data model 120 (e.g., to identify domains and/or relations). In some embodiments, the rules 164 include using types that are indicated in the data model 120 to identify a role of a data field (e.g., a role of a column). For example, a date or a location (e.g., country, city, etc.) is identified as a dimension, a number is identified as a metric, etc. In some embodiments, the rules 164 include using values identified in the database 200 to identify portions of the data (e.g., a text field with only country names is identified as a dimension, a text field with unique values is identified as an identifier of a dimension, etc.).

In some embodiments, an agent 112 shares information with at least one other agent (e.g., via communication bus 213 of the agent system 100 and/or through the communications network 20). The shared information includes, for example, information stored in database information store 114, skill module 130, sample request store 140, database query module 150, and/or data identifier module 160. For example, in some embodiments, it is desirable for a first agent 112-1 to share a training set (e.g., queries extracted from a database query log 128) with a second agent 112-2 for the purpose of training the second agent based on knowledge gained by the first agent.

In some embodiments, an agent 112 compares a database query log 128 with a data model 120 in order to enhance the data model. For example, if the data model 120 includes entities 210 for revenue and expenses, and a query log 128 includes a query for gross profit margin, the agent is trained from the query log to include a skill 132 that includes an indication of gross profit margin. Accordingly, the training set generated for the respective data model 120 includes the sample requests and/or database queries for gross profit margin.

The above identified modules (e.g., data structures, and/or programs including sets of instructions) need not be implemented as separate software programs, procedures or modules, and thus various subsets of these modules may be combined or otherwise re-arranged in various embodiments. In some embodiments, memory 102 stores a subset of the modules identified above. Furthermore, the memory 102 may store additional modules not described above. In some embodiments, the modules stored in the memory 102, or a non-transitory computer readable storage medium of memory 102, provide instructions for implementing respective operations in the methods described below. In some embodiments, some or all of these modules may be implemented with specialized hardware circuits that subsume part or all of the module functionality. One or more of the above identified elements may be executed by the one or more processors 176. In some embodiments, user device 300 includes one or more processors (e.g., as described with regard to processor 176; e.g., processor 374 of FIG. 4), and memory (e.g., as described with regard to memory 102; e.g., memory 302 of FIG. 4), and one or more of the modules described with regard to memory 102 is implemented on user device 300.

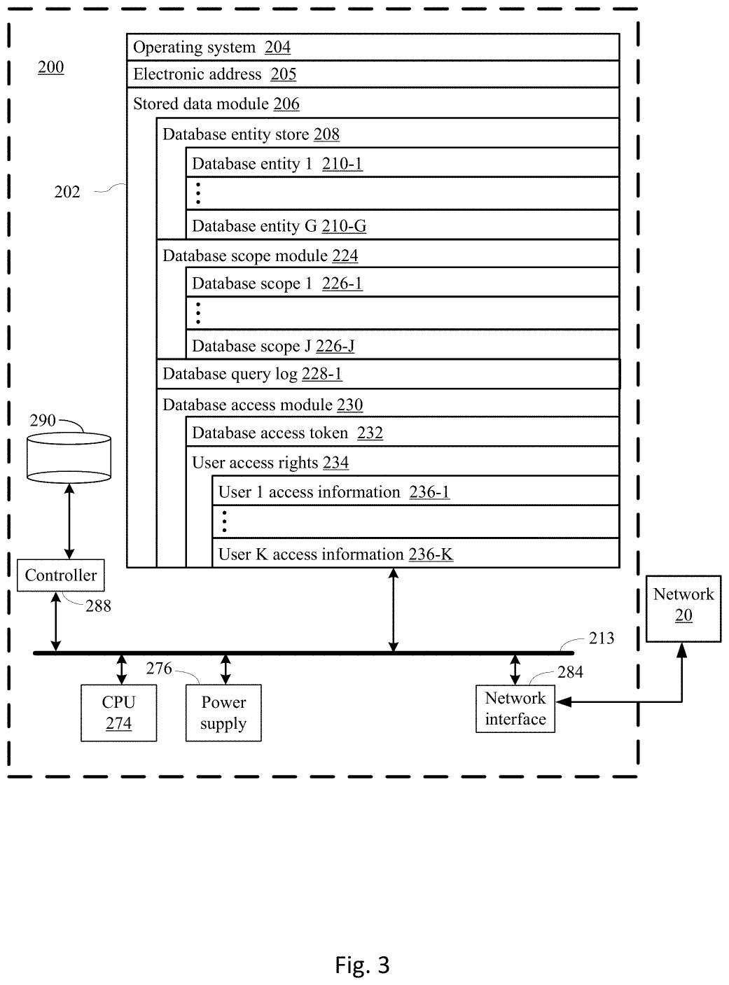

FIG. 3 provides a description of an exemplary database 200 (e.g., a database server and/or one or more database storage devices), in accordance with some embodiments. The database 200 illustrated in FIG. 3 has one or more processing units (CPUs) 274, a network or other communications interface 284, a memory 202 (e.g., random access memory), one or more magnetic disk storage and/or persistent devices 290 optionally accessed by one or more controllers 288, one or more communication busses 213 for interconnecting the aforementioned components, and a power supply 276 for powering the aforementioned components. In the present disclosure, database 200 may represent one or more databases (e.g., a set of databases), data sources, file stores, or a combination thereof. However, the present disclosure is not limited thereto (e.g., database 200 is a single database in a set of one or more databases)

It should be appreciated that the database 200 illustrated in FIG. 3 is only one example of a database (e.g., data store) that may be accessed by a respective agent 112 for data analytics, and that database 200 optionally has more or fewer components that shown, optionally combines two or more components, or optionally has a different configuration or arrangement of components. The various components shown in FIG. 3 are implemented in hardware, software, firmware, or a combination thereof, including one or more signal processing and/or application specific integrated circuits.

In some embodiments, the memory 202 of the database 200 stores:
an operating system 204 that includes procedures for handling various basic system services;
an electronic address 205 associated with the corresponding database 200 that is used by the agent system 100, the client devices 300, and/or the communications network 20 to identify the database and direct data communicated to and/or from the database; and
a stored data module 206 that includes procedures for storing data and handling queries for data stored on the database 200, the stored data module 206 including:
   a database entity store 208 that stores one or more database entities 210 (e.g., entity 210-1, . . . , 210-G) (e.g., a domain of the data, a relation of the data, etc.),
   a database scope module 224 that stores one or more database scopes 226 (e.g., database scope 226-1, . . . , 226-J), database scope 226 (e.g., defining a scope of access to data that corresponds to data stored by one or more databases),
   a database query log 228 that stores a history of a database (e.g., user connections and disconnections, a structured query language (SQL) statement, a database query log, etc.), and
   a database access module 230 that stores information related to accessing the database, the database access module 230 including:
      a database access token 232 used to restrict and/or grant access to the database 200, and
      user access rights 234 that stores information related to one or more user access rights 236 (e.g., user access information 236-1, . . . , 236-K), which control access to the database 200 as well as including various user information such as system administrator information, read and/or write privileges, etc.

Accordingly, the database entity store 208 stores one or more entities 210 of data stored on the database 200 (e.g., stored by stored data module 206). In some embodiments, the entities 210 are predefined by the data stored in the database 200 (e.g. a column is expressly labeled “Sales”), are extracted and/or extrapolated by a respective agent 112, are provided by a use of the system, or a combination thereof. For example, in some embodiments, one or more entities 210 are determined through a retrieved data model 120 associated with a respective database. Accordingly, these entities 210, or identifiers of entities, are stored for future reference.

In some embodiments, the database scope module 224 stores one or more database scopes 226 that define a scope of access to data that corresponds to data stored by one or more databases 200. This defined scope of data (e.g., one or more columns, tables, dimensions, relations, metrics, filters, pivots, and/or functions applied and/or available to apply to database 200) and/or the state of the selected subset of data (e.g., the presentation format and/or application state) as a data bookmark. The bookmark includes a pointer that, in accordance with a determination that the pointer is communicated to another user, is utilized to access the defined scope of data.

In some embodiments, the database 200 includes a database query log 228. The database query log 228 is accessed by respective agents 112. In some embodiments, the respective agents 112 are trained based on a training set that includes information determined from the database query log 228, such as various roles of entities 210 in the data stored on the database 200, as well as propose (e.g., extrapolate) new entities from these query logs for use in the training set.

In some embodiments, the database 200 includes the database access module 230 which facilitates (e.g., permits and/or restricts) access to data stored on the database. In some embodiments, access to the data stored on the database is limited by the one or more database scopes 226. In some embodiments, the database access module 230 stores at least one security token for controlling access to the one or more scopes of data defined by the database scopes 226. In some embodiments, a database scope 226 is associated with a particular user or group of users, and user access information 236 associated with the database scope is used to limit access to the scope of data defined by the database scope. In some embodiments, access to a database scope 226 is revoked by changing an entity stored by the database (e.g., at database scope 226 and/or user access information 236).

The above identified modules (e.g., data structures, and/or programs including sets of instructions) need not be implemented as separate software programs, procedures or modules, and thus various subsets of these modules may be combined or otherwise re-arranged in various embodiments. In some embodiments, memory 202 stores a subset of the modules identified above. Furthermore, the memory 202 may store additional modules not described above. In some embodiments, the modules stored in the memory 202, or a non-transitory computer readable storage medium of memory 202, provide instructions for implementing respective operations in the methods described below. In some embodiments, some or all of these modules may be implemented with specialized hardware circuits that subsume part or all of the module functionality. One or more of the above identified elements may be executed by the one or more processors 274. In some embodiments, user device 300 includes one or more processors (e.g., as described with regard to processor 176; e.g., processor 374 of FIG. 4), and memory (e.g., as described with regard to memory 102; e.g., memory 302 of FIG. 4), and one or more of the modules described with regard to memory 202 is implemented on a user device 300.

FIG. 4 provides a description of a user device 300 that can be used with the instant disclosure. In some embodiments, the user device has one or more processing units (CPUs) 374, a network or other communications interface 384, a memory 302 (e.g., random access memory), one or more magnetic disk storage and/or persistent devices 390 optionally accessed by one or more controllers 388, one or more communication busses 313 for interconnecting the aforementioned components, and a power supply 276 for powering the aforementioned components. In some embodiments, the user device 300 includes a user interface 378 for interacting with an agent 112 and/or database 200. The user interface includes a display 382 to display information and an input means 380 (e.g., a keyboard) for inputting instructions and/or commands. In some embodiments, the input means 280 and the display 382 are subsumed as a single device (e.g., a touch screen display). In the present disclosure, database 300 may represent one or more databases, data sources, file stores, or a combination thereof. In the interest of brevity and clarity, only a few of the possible components of the user device 300 are shown in order to better emphasize the additional software modules that are installed on the user device 300. In some embodiments, memory 302 of the user device 300 for analyzing data stores:
an operating system 304 that includes procedures for handling various basic system services;
identifying information 305 (e.g., an electronic address, such as an IP address) associated with the corresponding user device 300 that is used by the agent system 100 to identify user devices 300 and/or data communicated with the user devices; and
a user database query store 306 that stores a database user query log 308 for database 200 associated with the user and/or user of the user device 300, where a respective database user query log 308 includes one or more stored user queries 310.

In some embodiments, the user database query store 306 is accessed by, or communicated to, an agent 112 that is associated with the corresponding user device 300. Using a query log provided by a user enables the respective agent to be trained based a training set that includes information derived from the contents of the user database query store 306. In some embodiments, a database user query log 308 stores a history of user queries for the corresponding database (e.g., database user query log 308-1 stores a history of user queries for the corresponding database 200-1). In some embodiments, the user database query store 306 stores a history of conversations between the user device 300 and another user device or external server. For example, if a user discusses data with another user through an instant messaging application, and a history of this conversation is stored within the user device 300 (e.g., in the user database query store 306), this conversation history is accessible by a respective agent 112. Accessing this information allows the agent to be trained based on these real, natural conversations and include this information in a respective training set. This training augments and improves an ability of the agent to provide specific purpose (e.g., subject matter specific) responses to natural language queries on that respective database. The training set that includes information derived from these logs is utilizable by other agents, which improves the abilities of the other agents.

In some embodiments, user device 300 is, for example, a portable electronic device (e.g., portable communications device, tablet computer, laptop computer, and/or wearable device), desktop computer, and/or server computer.

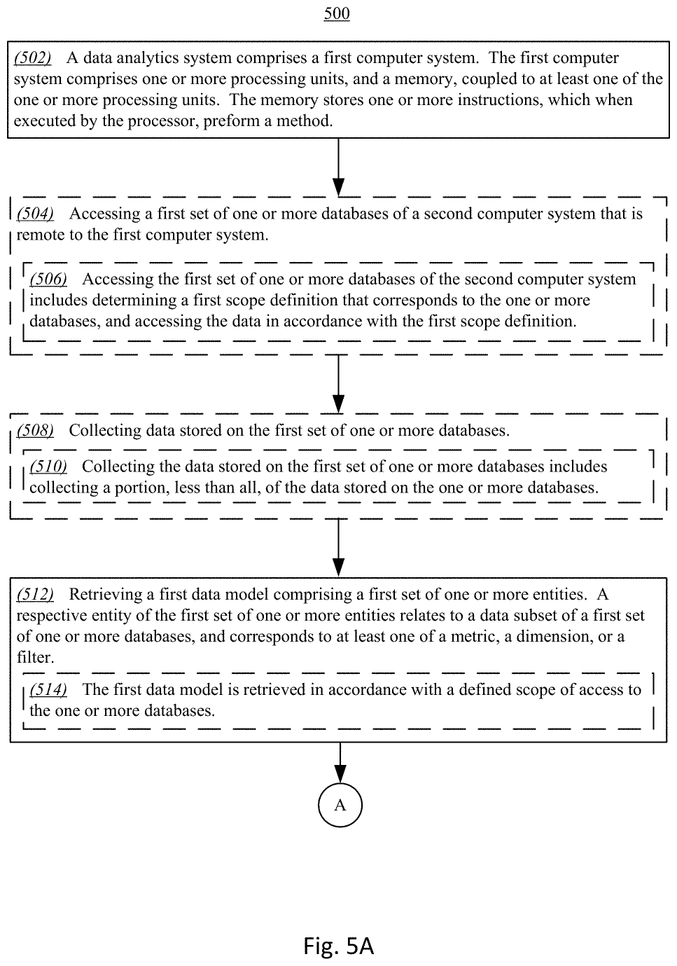

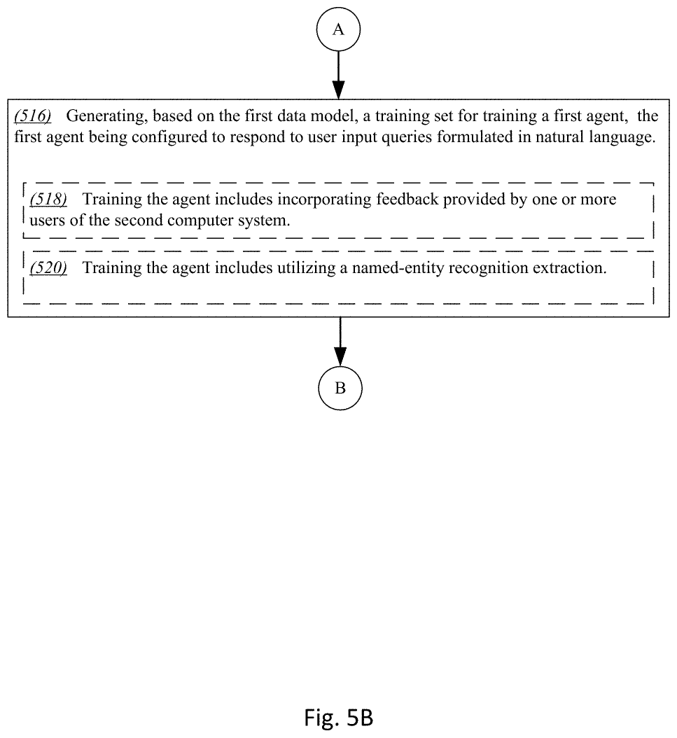

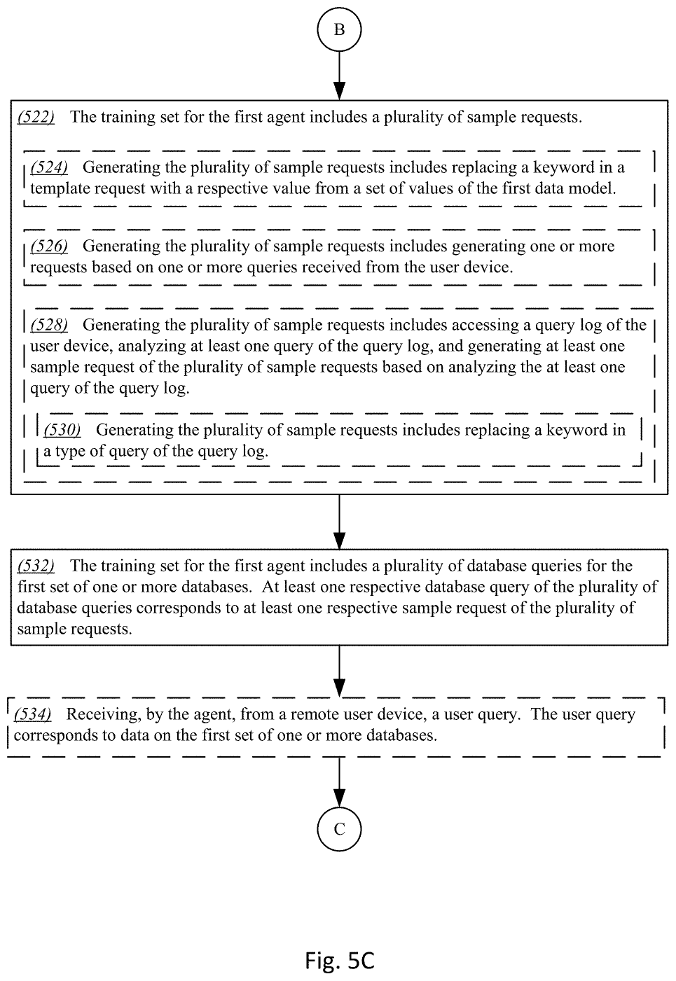

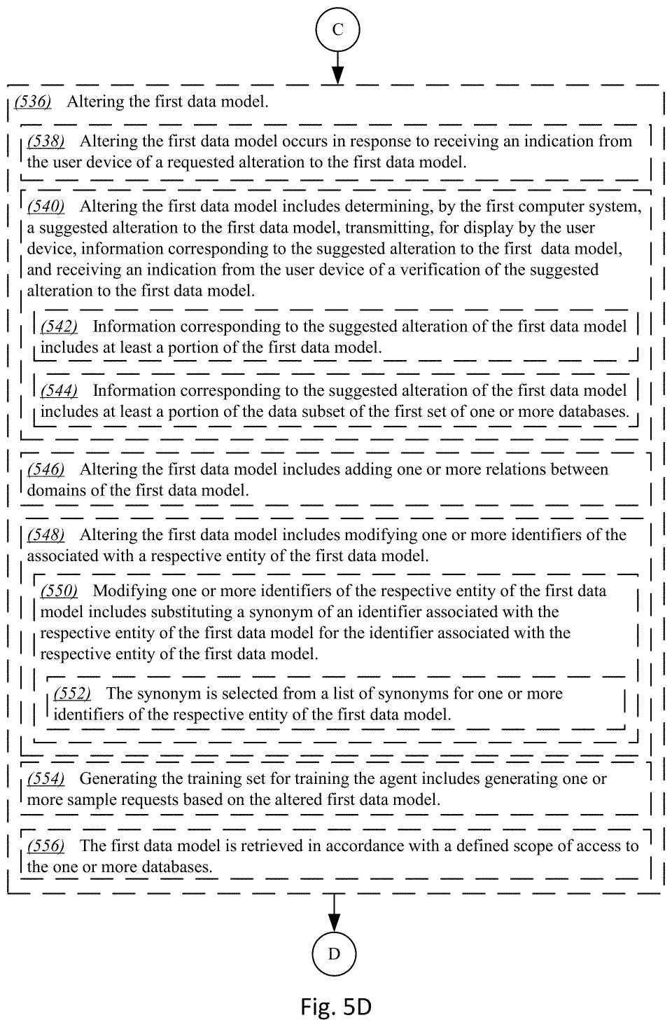

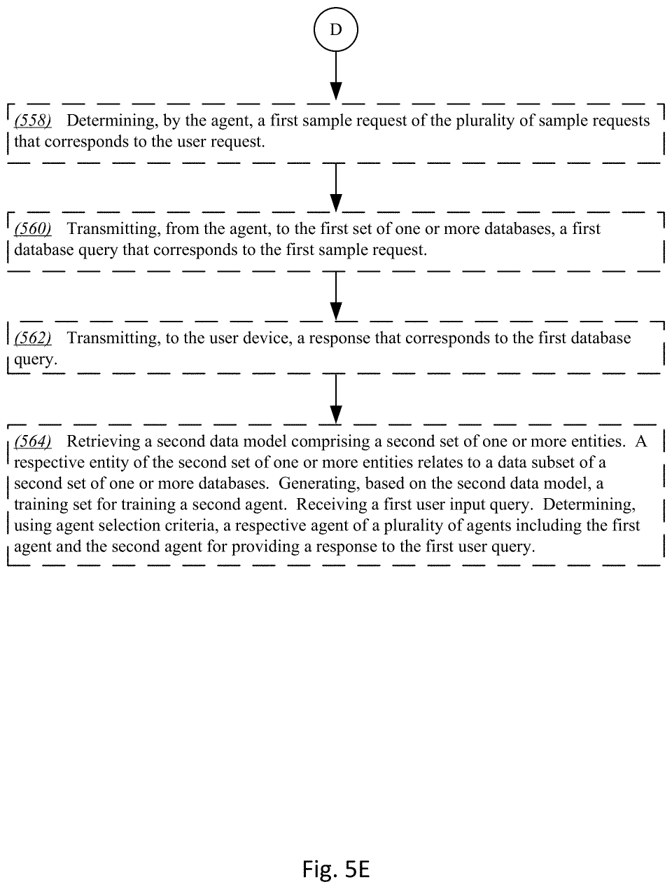

FIG. 5 illustrates a flow chart of methods for automating a data analytics platform in accordance with embodiments of the present disclosure. In the flow chart, the preferred parts of the methods are shown in solid line boxes whereas optional variants of the methods, or optional equipment used by the methods, are shown in dashed line boxes.

FIGS. 5A through 5D are flow diagrams illustrating a method 500 for generating a training set (e.g., a plurality of sample requests and database queries) for an agent, in accordance with some embodiments. The method 500 is performed at a device, such as agent system 100. For example, instructions for performing the method 500 are stored in the memory 102 and executed by the processor(s) 176 of agent system 100. In some embodiments, one or more operations described with regard to method 500 are performed by database 200 and/or user device 300. For example, instructions for performing the method 500 are stored in the memory 202 and executed by the processor(s) 274 of database 200 and/or instructions for performing the method 500 are stored in the memory 302 and executed by the processor(s) 374 of user device 300.

Block 502.

With reference to block 502 of FIG. 5A, a goal of embodiments of the present disclosure is to automate a data analytics system. The data analytics system includes a first computer system (e.g., agent system 100 of FIGS. 1 and 2). The first computer system includes one or more processing units (e.g., CPU 174 of FIG. 2), and a memory (e.g., memory 102 and/or memory 190 of FIG. 2), which is coupled to at least one of the one or more processing units. The memory stores one or more instructions, which when executed by the processor, perform a method.

Block 504.

Referring to block 504 FIG. 5A, in some embodiments, the method includes accessing a first set of one or more databases (e.g., database 200 of FIGS. 1 and 3). In some embodiments, one or more databases 200 in a first set of one or more databases is remote to the first computer system (e.g., the agent 112 accesses one or more databases remotely). In some embodiments, an agent 112 of the agent system 100 is associated with one or more databases 200 (e.g., a first agent 112-1 is associated with a first database 200-1 as well as a second database 200-3, while a second agent 112-2 is associated with a third database 200-3). Having agent 112 be associated with one or more databases 200 allows agent 112 to be tailored to a particular database or set of databases (e.g., databases affiliated with an organization, industry, entity, and/or categorization) to provide specific purpose responses to natural language queries on the respective databases. However, the present disclosure is not limited thereto. In some embodiments, accessing the corresponding database 200 requires providing credentials and/or privileges to the database. As discussed above, in some embodiments, the credentials and/or privileges are provided by a user in accordance with a determination that an agent 112 does not have access to a database 200 or database scope 226 (e.g., an initial accessing of a database). In some embodiments, the credentials and/or privileges are stored by a respective agent 112 to allow the agent to access the database without human interaction.

In some embodiments, a respective agent 112 is trained to determine whether to access a first database 200-1 or a second database for responding to a user-input query. For example, if a first database 200-1 stores information related to sales at a state-wide level and a second database stores information related to sales at a country-wide level, the corresponding agent 112, which has access to both the first database and the second database, may determine whether to access the first database, the second database, or both databases to provide a response to the user-input query.

Block 506.

Referring to block 506 of FIG. 5A, in some embodiments, accessing the first set of one or more databases 200 includes determining a first scope definition (e.g., database scope 226 of FIG. 3) of access to the data stored on the one or more databases. In some embodiments, the first scope definition corresponds to a respective database 200, such that a database includes one or more scopes 226. However, the present disclosure is not limited thereto. For example, in some embodiments, the first set of one or more databases is limited by a scope 226. As described above, a scope definition 226 includes information that defines a scope of access to data that corresponds to data stored by one or more databases 200 that are in the network 20 (e.g., one or more columns, tables, dimensions, relations, metrics, filters, pivots, and/or functions applied and/or available to apply to database 200) and/or a state of the selected subset of data (e.g., the presentation format and/or application state). In some embodiments, scope 226 is defined by a user (e.g., an administrator of database 200). Accordingly, in some embodiments, the data in the corresponding database 200 is accessed in accordance with the respective scope 226. In some embodiments, scope 226 includes information that indicates a portion, less than all, of the data stored by the one or more databased (e.g., database 200). For example, a portion, less than all, of the data includes data from (and/or data determined based on) one or more of a column, a set of columns, a table, a set of tables, a database, a set of databases, and/or a view that includes data from one or more tables from one or more databases. In some embodiments, the scope 226 includes information about part or all of the data model of one or more databases. In some embodiments, the defined scope 226 of access to the respective database 200 restricts the data that is collected. In some embodiments, the defined scope 226 is saved as a data bookmark. Additional information regarding data bookmarks is available in United States Patent Publication No. 2018/0129816, entitled “Data Bookmark Distribution,” which is hereby incorporated by reference in its entirety.

Blocks 508 and 510.

Referring to blocks 508 and 510 of FIG. 5A, in some embodiments, the method includes collecting data stored on the first set of one or more databases 200. For example, in some embodiments, collecting data stored on a corresponding set of databases 200 includes retrieving a corresponding data model 120 (e.g., a schema) for the databases. As described above, in some embodiments, collecting data stored on a corresponding set of databases 200 includes retrieving a data model 120 for a subset of databases in the set of databases. In some embodiments, a portion, less than all, of the data stored on the database 200 is collected. For example, in some embodiments, a bookmark (e.g., database scope 226) restricts the agent 112 from accessing portions of the database 200.

Block 512.

Referring to block 512 of FIG. 5A, in some embodiments, the method includes retrieving a first data model 120. The first data model includes a first set of one or more entities, which define information stored in the database. As described above, an entity relates to a data subset of the set of one or more databases. In some embodiments, an entity corresponds to at least one of a column, a table, a dimension, a relation (e.g., joining tables), a metric, a filter, a pivot, and/or a function that is applied and/or available to apply to the set of one or more databases 200. In accordance with a determination that the logs (e.g., SQL statements in logs) associated with the respective database include particular information, this information can be used to retrieve the data model 120. For example, if a column is used in a particular role (e.g., in one or more aggregations the column is identified as a metric, in a group clause the column is identified as a dimension, a where clause using “=” the column is identified as a filter, a where clause using “>” or “between” the column is identified as a metric, etc.), then the nature of the column (e.g., data model 120) can be retrieved.

Block 514.

Referring to block 514 of FIG. 5A, in some embodiments, the first data model is retrieved in accordance with a defined scope of access to the one or more databases. For instance, in some embodiments, a first agent has access to a portion of data (e.g., a subset of data) that is stored on a set of one or more databases. Accordingly, in some embodiments, a data model that is retrieved for the portion of data accessible to the agent is different than another data model that is retrieved for all the data stored in the set of one or more databases. However, the present disclosure is not limited thereto as, in some embodiments, these retrieved data models are the same.

Block 516.

Referring to block 516 of FIG. 5B, in some embodiments, the method includes generating a training set for training a first agent 112 to respond to user input queries (e.g., queries that are formulated in a natural language) based on the data model 120. For example, training the agent 112 through the training set allows the agent to provide responses to user input queries in accordance with training data that is specialized to data stored in the respective set of one or more databases 200 that are accessible to the agent (e.g., based on the identified data model). For example, a first agent 112-1 is associated with a set of one or more databases 200-1 that store information related to Basketball statistics, and so the first agent becomes specialized in natural language queries provided by users associated with Basketball, whereas a second agent 112-2 is associated with a set of one or more databases 200-2 that store information related to air quality control, and so becomes specialized in natural language queries provided by users associated with air quality control. Accordingly, the first agent 112-1 will recognize a user query that includes a term “ppm” to mean points-per-minute in a basketball sense, whereas the second agent 112-2 will recognize a user query that includes the term “ppm” to mean parts-per-million in a stoichiometric sense. The first agent 112-1 will recognize a user query that includes a term “Ca” to mean either California or Canada in a basketball sense and can differentiate between the two according to a content of the user query (e.g., a user query of “What is a salary differential between players in CA compared to NY?” compared to a user query of “Where does CA rank compared to USA?”), whereas the second agent 112-2 will recognize a user query that includes the term “Ca” to mean Calcium. These differences are determined through the identified data model associated with a respective set of databases, and incorporated in the respective training sets.

Block 518.

Referring to block 518 of FIG. 5B, in some embodiments, training the agent 112 includes incorporating feedback provided by one or more users of the second computer system (e.g., user feedback provided through a user device 300). For example, in some embodiments, an agent 112 may determine multiple potential database queries that correspond to a user input request (e.g., queries that specify “California” or “Canada” as a filter, in response to a user request that includes the abbreviation “CA”), and may provide the user with an option to select among multiple options that correspond to the multiple potential database queries. In some embodiments, training agent 112 includes adjusting a response model (e.g., adjusting, adding, and/or altering one or more sample requests in a plurality of generated sample requests) based on user input, such as user selection of an option that corresponds to a potential database query. In some embodiments, the user feedback and/or input includes adding one or more relations between one or more entities of the data model (e.g., between identified domains), renaming one or more entities (e.g., renaming a dimension from “rev” to “revenue”), identifying one or more data fields as a dimension, a metric, and/or a filter, adding one or more virtual metrics based on a combination of previously identified metrics (e.g., a virtual metric of profit based on identified metrics of cost and revenue), adding one or more synonyms for an entity (e.g., a dimension value, a metric name, and/or a dimension name), and the like.

In some embodiments, training the agent 112 includes analyzing the one or more entities 210 of the data model 120 to create one or more new entities of the data model. For example, if a first entity is identified as a table listing revenue a second entity is identified as a table listing costs, a third entity is created and identified as a table listing profits. In some embodiments, the created entity is stored in a corresponding database entity store 208.

Block 520.

Referring to block 520 of FIG. 5B, in some embodiments, training the agent includes utilizing a named-entity recognition (NER) extraction. For example, NER extraction identifies known metrics, dimensions, and filters. In some embodiments, the NER is a general architecture for text engineering (GATE) platform, an Apache OpenNLP library platform, an unstructured information management architecture (UIMA) platform, or SpaCy library platform. One of skill in the art of the present disclosure will recognize that other natural language processing systems and or NERs may be used.

Block 522.

Referring to block 522 of FIG. 5C, in some embodiments, the training set for training an agent (e.g., agent 112-1 of the agent system 100 of FIGS. 1 and 2) includes a plurality of sample requests (e.g., sample request 142 of FIG. 2) for the agent. As previously described (e.g., with regard to FIG. 2), these sample requests 142 are, for example, natural language phrases and/or sentences that describe a request for information that includes and/or is based on data stored by a database 200. As a training set is generated and developed, the sample requests therein are also refined and developed in order to allow the training set to improve in quality and be utilized by other agents.

Block 524 Through 530.

Referring to blocks 524 through 530 of FIG. 5C, in some embodiments, training the agent includes generating the sample requests 142 by replacing a keyword in a template request (e.g., a predetermined sample request 142). For example, replacing a keyword in a template request substitutes a keyword in the template request 142 with a respective value from a set of values (e.g., entities) of the data model 120 (e.g., a set of values of a column of the data model). For example, a sample request is, “What was our revenue for wine?” and “wine” is a value in a column of the data model 120 (e.g., a column of “beverages”) that also includes the values “beer,” “liquor,” and “soft drinks.” Additional natural language sentences (e.g., sample requests 142) that are generated include “What was our revenue for beer?”, “What was our revenue for liquor?”, etc.). In some embodiments, generating the sample requests 142 includes generating one or more requests based on one or more queries received from the user device 300 (e.g., user queries 310 of the database user query logs 308 of FIG. 4). In some embodiments, generating the sample requests 142 includes accessing a query log of the user device 300. Within this query log of the user device 300, at least one query is selected for analysis. Accordingly, in some embodiments, at least one sample request 142 is generated based on analysis of one or more queries of the query log. In some embodiments, the method includes replacing a keyword in a query of the query log (e.g., with values from a column in a database). For instance, if a query of “What was our revenue last week?” is identified in a user query log, then a replacement query of “What was our revenue for the last seven days?” is generated for a respective training set.

In some embodiments, analysis of a log is used to determine that an entity (e.g., a column) is used in a particular role. For example, in accordance with a determination that an entity is used in an aggregation (e.g., a sum) the entity is determined to be a metric; in accordance with a determination that an entity is used in a group by clause (e.g., a pivot), the entity is determined to be a dimension; in accordance with a determination that an entity is used in a where clause that includes the symbol “=”, the entity is determined to be a filter, and in accordance with a determination that an entity is used in a where clause that includes they symbol “>” or the term “between,” the entity is determined to be a metric.

In some embodiments, a potential role that corresponds to an entity of a data model 120 is determined. In some embodiments, a confidence level (e.g., between 0 and 1) is assigned to a role that is determined to correspond to an entity. The confidence level indicates a degree of confidence of a role determined to correspond to an entity. In some embodiments, in accordance with a determination that a confidence level is above a first threshold (e.g., a high range threshold that is approximately 1, such as 0.9), a user is not required to validate the entity. In some embodiments, in accordance with a determination that a confidence level is below a second threshold (e.g., a low range threshold that is lower than the first threshold and approximately 0, such as 0.1), a user is presented with a list of suggested options and is prompted to enter a correct value. In some embodiments, in accordance with a determination that a confidence level is below a third threshold (e.g., a threshold, such as a mid-range threshold (e.g., 0.5), that is between the first threshold and the second threshold), a user is required to validate the entity (e.g., by disambiguating between a set of highest-rated propositions).

Block 532.

Referring to block 532 of FIG. 5C, in some embodiments, the training set for training an agent includes a variety of database queries 152 for the corresponding database 200. For example, a respective query 152 in the generated queries corresponds to a respective sample request 142 of the generated sample requests (e.g., sample requests 142 of FIG. 2 and block 522 of FIG. 5C). In some embodiments, a generated database query 152 and a sample request 142 have a one-to-one relationship, such that a sample request has a particular associated query. In some embodiments, more than one sample request 142 is associated with a database query 152. In some embodiments, more than one database query is associated with a sample request.

Block 534.

Referring to block 534 of FIG. 5C, in some embodiments, the method includes receiving a user query from a respective user device (e.g., user device 300 of FIGS. 1 and 4). This user query is received by the corresponding agent 112, which is associated with the database 200 that the user query is directed for (e.g., agent 112-4 receives a user query from user device 300-6 for database 200-3). The user query is a request for data and/or information on, or related to, the corresponding database 200 and is input by the user using natural language sentences (e.g., a query of “How many units were sold by a salesperson in the fourth quarter for the past twelve years?”).

Blocks 536 Through 556.

Referring to block 536 of FIG. 5D, in some embodiments, the method includes altering the data model 120 and/or the training set associated with the respective data model. In some embodiments, this altering of the data model 120 includes altering one or more entities of the data model. Referring to blocks 546 and 548 of FIG. 5D, in some embodiments, these alterations include adding relations between discovered domains (e.g., joining tables), renaming a dimension (e.g., renaming “rev” into “revenue”), identifying data fields in a dimensions (e.g., identifying a data field as a metric or identifying a data field as a filter), adding auxiliary (e.g., virtual) metrics based on a combination of identified metrics (e.g., adding profit as a difference of revenue and costs), and/or adding synonyms for metric names (e.g., adding one or more synonyms for a particular term), dimension names (e.g., renaming an identifier), and/or dimension values (e.g., altering a value of 0.0001 to be 1*10⁴). Referring to block 538 of FIG. 5D, in some embodiments, the data model 120 is altered in response to receiving an indication from the user device 300 of a required alteration to the data model 120 (e.g., through the user interfaces of FIGS. 6 through 9). In some embodiments, the data model 120 is not altered by the systems and methods of the present disclosure. For example, in some embodiments, the altering of the present disclosure (e.g., altering by a user device 300 and/or agent 112) alters one or more names of one or more data fields. The altering of the name of a data field allows for a user to interact with, request, and/or query for information related to that data field using natural language (e.g., the altered name), without altering the underlying data.

Referring to block 550 of FIG. 5D, in some embodiments, modifying one or more identifiers of the one or more entities of the data model 120 includes substituting a synonym of an identifier associated with the respective entity of the data model 120 for the identifier associated with the respective entity of the data model. For example, an identifier of an entity of the data model 120 includes a name of dimension in the respective database (e.g., a name of a column of a table in the database) and modifying an identifier includes modifying the name of the dimension. In some embodiments, a synonym (e.g., derived from a predetermined list of synonyms and corresponding terms) is substituted for an identifier of an entity. For example, if an identifier includes the abbreviated expression “rev” to refer to revenue, the identifier is modified to substitute predefined synonym “Revenue” (or “Earnings”) for the term “rev.”

In some embodiments, modifying the one or more entities of the data model includes modifying (e.g., automatically and/or in response to user input) data stored by the database. In some embodiments, a synonym (e.g., derived from a predetermined list of synonyms and corresponding terms) is substituted for a data value stored by the database. For example, if an identifier includes the abbreviated expression “CA” to refer to the state California, the data value is modified to substitute predefined synonym “California” for the data value “CA.”

Block 552.

Referring to block 552 of FIG. 5D, in some embodiments, the training set of one or more entities for the agent 112 includes a set (e.g., a list) of synonyms for one or more entities of the data model 120. For example, in some embodiments, a first agent 112-1 generates a set of synonyms for an entity of the data model. For example, in some embodiments, the set of synonyms is generated by analyzing one or more query logs (e.g., database query log 228 of FIG. 3). For example, in some embodiments, the one or more query logs includes a first query (e.g., a query for “What percentage of revenue was lost from taxes in California?”) and a second query that is similar to the first query (e.g., a query for “What percent of revenue was lost from taxes in CA?”). Accordingly, the generated set of synonyms will include a synonym for “CA” as “California,” which is determined through analysis of the one or more query logs 228. In some embodiments, the set of synonyms is provided by, and/or augmented by, a user (e.g., as described in more detail below with reference to at least FIG. 6 through FIG. 9). In some embodiments, a second agent 112-2 utilizes the set of synonyms generated by, and/or provided for, the first agent 112-1. In some embodiments, a second agent 112-2 utilizes the set of synonyms generated by, and/or provided for, the first training set. In some embodiments, the set of synonyms is a skill 132 of the data model 120. In this way, the second agent 112-2 incorporates knowledge gained by the first agent 112-1 while an augmenting the set of synonyms through the methods sand systems of the present disclosure. As another non-limiting example, in some embodiments, one or more entities of the respective data model 120 is compared with a list of common terms of the respective data model. For example, if a database (e.g., associated data model) is retrieved and associated with a travel industry, a list of synonym and common travel terms is used in the training set for the respective agent of the data model. In some embodiments, this training set includes terms such as a list of various cities, airports, and airline names and their respective synonyms. The sample requests and the database queries that are generated by, and/or provided to, an agent from this training set is augmented through the alteration of various descriptive semantics of entities in the data model 120. For example, in some embodiments, the alteration of various descriptive semantics of entities in the data model 120 includes providing natural language synonyms of one or more fields (e.g., names) of a dimension in the data model. These natural language synonyms allow a respective agent 112 to communicate with, and provide improved query results for, users of the present disclosure by interpreting requests provided the respective user using the natural language synonyms.

Block 540.

Referring to block 540 of FIG. 5D, in some embodiments, altering the data model 120 includes determining, by the first computer system (e.g., the agent 112), a suggested alteration to the data model and/or entity of the data model. Once the suggested alteration is determined, the suggested alteration to the data model is transmitted to the user device 300 for display. An indication is received from the user device 300 of a verification of the suggested alteration to the data model. This allows for the agent to create and suggest alterations to the data model 120 and/or entities of the data model, which are then verified by a user for accuracy and/or relevancy. For example, in some embodiments, the agent 112 proposes an alteration (e.g., a synonym) to the data model 120 that is derived from a dictionary (e.g., using a dictionary to evaluate a metric called “revenue,” it is determined that an additional metric called “income” is also to be included). Referring to block 542 of FIG. 5D, in some embodiments, the transmission of information corresponding to the suggested alteration of the data model 120 to the user device 300 includes at least a portion of the data model 120. For example, in some embodiments, only the portions of the data model 120 that are related to the suggested alteration of the data model is included. Referring to block 544 of FIG. 5D, in some embodiments, the transmission of information corresponding to the suggested alteration of the data model 120 to the user device 300 includes at least a portion of the collected data (e.g., a suggested alteration of joining two tables only includes those two tables).

Referring to block 554 of FIG. 5D, in some embodiments, generating the plurality of sample requests 142 for a respective training set includes generating one or more sample requests based on the altered data model 120. For example, if the altered data model 120 creates a new dimension, then one or more sample requests 142 are generated for this alteration. Referring to block 556 of FIG. 5D, in some embodiments, the first data model is retrieved in accordance with a defined scope of access to the one or more databases associated with the first data model. In some embodiments, collecting data that is stored on the database 300 includes collecting data in accordance with a defined scope of access (e.g., scope 226) to the database (e.g., defined in a data bookmark). In some embodiments, altering the data model 120 includes modifying the defined scope of access.

Block 558.

Referring to block 558 of FIG. 5E, the method includes determining a sample request 142 (e.g., a first sample request in the generated sample requests), which corresponds to the user request, with the agent 112. For example, if a user request is “What is the revenue for beer?”, a sample request which is similar to the user request is determined.

Blocks 560 and 562.

Referring to blocks 560 and 562 of FIG. 5E, in some embodiments, the method includes transmitting, from the respective agent 112 to the corresponding database 200, a database query 152 which corresponds to the determined sample request 142. This database query 152 retrieves information from the database 200 related to the user request. In some embodiments, the method includes transmitting, to the user device 300, a response (e.g., an output) which corresponds to the database query 152. This provides the user with the requested information of the database 200 without having to program the agent or know a programming language to communicate with a respective database.

Block 564.

Referring to block 564 of FIG. 4E, in some embodiments, the method includes retrieving a second data model (e.g., data model 120-2), which includes a second set of one or more entities. A respective entity of the second set of one or more entities relates to a data subset of a second set of one or more databases. A training set for training a second agent (e.g., agent 112-2) is generated based on the second data model. A user input query is received from a user. Using agent selection criteria, such as a best-fit criterion, a respective agent of a plurality of agents including the first agent and the second agent is determined for providing a response to the first user query.

Referring to FIGS. 6 through 9, embodiments of a user interface for creating and editing one or more skills 132 are described, in accordance with some embodiments. In some embodiments, one or more of the user interfaces described with regard to FIGS. 6-9 is displayed by a display 382 of user device 300. In some embodiments, the one or more user interfaces described with regards to FIGS. 6-9 include a dedicated application (e.g., a desktop application or a mobile application). In some embodiments, the one or more user interfaces described with regards to FIGS. 6-9 include an extension (e.g., an add-on) to a database 200.

The user interface depicted in FIG. 6 enables a user device 300 to create a new skill 602 with an associated description 604. In some embodiments, a skill 602 (e.g., skill 132 of FIG. 3) is input by the user using the user interface 384 of the user device 300. In some embodiments, the skill 602 is used by an agent 112 for data analysis of a corresponding database 606 and/or domain 608 (e.g., database 1). As depicted in FIG. 6, a skill 602 that is provided (e.g., generated) by a user requires the user to input a name of the skill. In some embodiments, the user provides a description 604 of the corresponding skill in order to allow other users of the present disclosure to understand what the respective skill provides (e.g., a description of “Synonyms for states in the United States.”). In some embodiments, the user selects at least one database 200 to which the skill 602 is associated with. in some embodiments, the user selects at least one domain of a data model 120 of the database 200. As described above, the present disclosure is not limited to providing synonyms of entities of the data model 120. For instance, in some embodiments, the user provided skill 602 is a formula applied to data stored in a database.

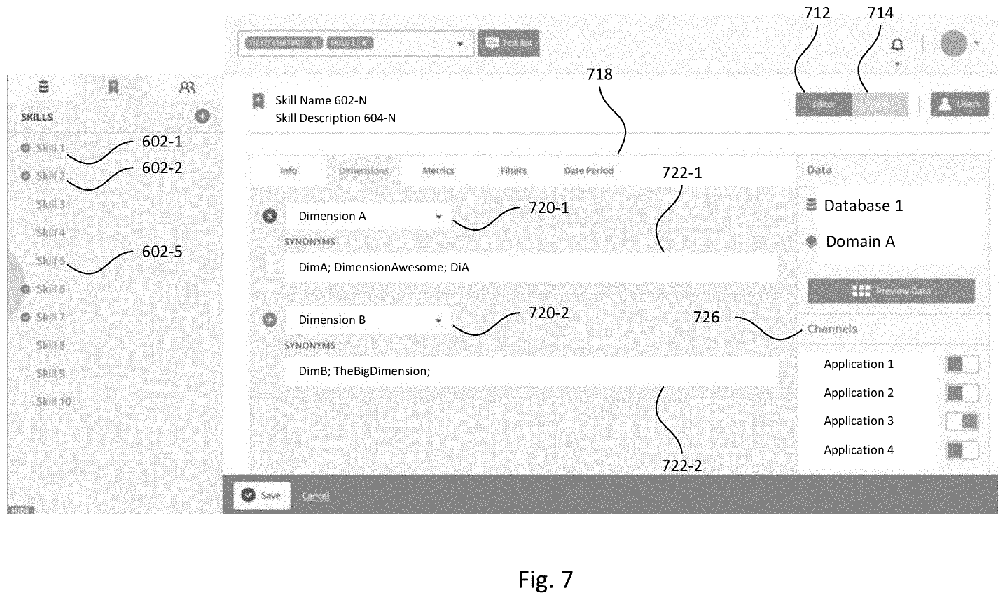

The user interface depicted in FIG. 7 enables alterations of one or more entities (e.g., dimensions 720-1, 720-2) of a skill 602 (e.g., as created via the user interface described with regard to FIG. 6). For example, a user provides input to alter entity “Dimension A” by altering the title of the entity and/or by providing synonyms for the entity, as indicated at input field 722-1. In some embodiments, the user provides an input to alter another entity “Dimension B” by altering the title of the entity and/or by providing synonyms for the entity, as indicated at input field 722-2. Accordingly, in some embodiments, the skill 602-N provides training set of one or more entities of the respective data model 120 (e.g., database 1 of FIG. 6 through FIG. 9). In some embodiments, the skill 602-N that is created by the user is then shared with, and/or accessed through, channels 726. For example, in some embodiments, the skill 602-N is listed in a market place of skills that is accessible to users of the present disclosure. In some embodiments, channels 726 include one or more applications (e.g., an instant messaging application) via which user devices 300 and various agents 112 communicate with one another. For example, as depicted in FIG. 7, a first user 300-1 creates the skill 602-N which provides a training set of synonyms 722-1 for dimension A 720-1 and synonyms 722-2 for dimension B 720-2. The user also selects which channels 726 that utilize the skill 602-N. Accordingly, in some embodiments, a second user 300-2 which is in communication with one or more of the selected channels 726 provides a natural language query to a respective agent 112 of the database, and the agent is able interpret the natural language provided by the second user using the training set provided by the skill 602-N. In other words, in some embodiments, the user enters one or more synonyms (e.g., modified identifier) to describe the respective dimensions and values in natural language. Accordingly, in some embodiments, there is at least one alternate semantic description of the one or more dimensions and/or value of train a skill 132 of the respective agent 112. Thus, the agent 112 is enabled to convert a natural language entity (e.g., “in California”) into a dimension and/or a value (e.g., dimension=“state,” and/or value for state=“CA”) of the data model 120.

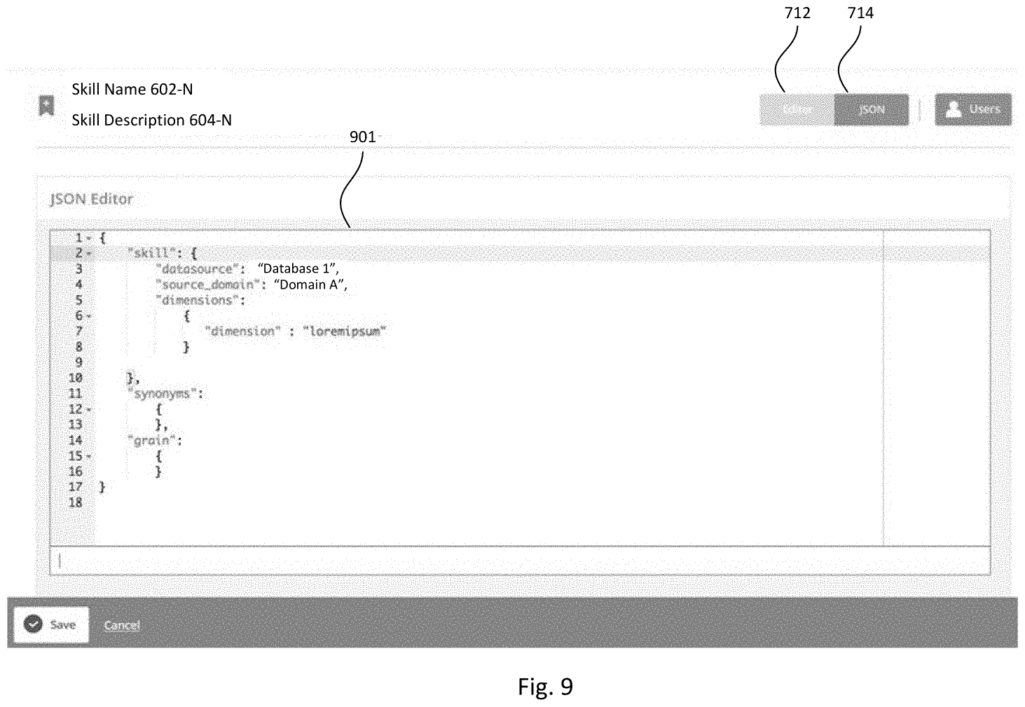

Users are enabled to configure skills 132 using the user interface illustrated in FIG. 7 (e.g., editor 712), or through a more advanced editor (e.g., such as a command line interface (CLI) editor), which is illustrated in FIG. 9. Selection of the editor is enabled through toggle buttons 712 and 714 (e.g., simple format 712 or advanced CLI format 714). However, the present disclosure is not limited thereto. For example, in some embodiments, the user interface includes a number of other controllable objects such as switches. In some embodiments, in accordance with a determination that the skill 132 is created by the user, it is held private for just the user or users with access to the database. In some embodiments, the skill 132 is published publicly (e.g., option 802). Having a public skill 132 allows a user to benefit from the work of other users that have already set up an agent 112 on a similar database 200. For example, in some embodiments, users may share skills 132 through a dedicated marketplace. The marketplace allows users of different agents 112 to explore other skills 132 and applies these skills to their database 200 and/or agent 112, augmenting and improving the capabilities of the agent.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 102, memory 190, memory 202, memory 290, memory 302, memory 390) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 202 optionally includes one or more storage devices remotely located from the CPU(s) 274. Memory 202, or alternatively the non-volatile memory device(s) within memory 202, comprises a non-transitory computer readable storage medium.

Stored on any one of the machine readable medium (media), features of the present invention can be incorporated in software and/or firmware for controlling the hardware of a processing system, and for enabling a processing system to interact with other mechanism utilizing the results of the present invention. Such software or firmware may include, but is not limited to, application code, device drivers, operating systems, and execution environments/containers.

Communication systems as referred to herein (e.g., network interface 186) optionally communicate via wired and/or wireless communication connections. Communication systems optionally communicate with networks (e.g., network 20), such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A data analytics system comprising a first computer system, the first computer system comprising:
one or more processing units; and
a memory, coupled to at least one of the one or more processing units, the memory comprising instructions for:
retrieving a first data model comprising a first set of one or more entities, wherein a respective entity of the first set of one or more entities:
relates to a data subset of a first set of one or more databases, and
corresponds to at least one of a metric, a dimension, or a filter; and
generating, based on the first data model, a training set for training a first agent, the first agent being configured to respond to user input queries formulated in natural language, the training set for training the first agent including:
a plurality of sample requests, and
a plurality of database queries for the one or more databases, wherein at least one respective database query of the plurality of database queries corresponds to at least one respective sample request of the plurality of sample requests.

2. The system of claim 1, wherein the memory further comprises instructions for:
receiving, by the first agent, from a remote user device, a user query, wherein the user query corresponds to data on the first set of one or more databases; and
determining, by the first agent, a first sample request of the plurality of sample requests that corresponds to the user query;
transmitting, from the first agent, to the first set of one or more databases, a first database query that corresponds to the first sample request; and
transmitting, to the user device, a response that corresponds to the first database query.

3. The system of claim 1, wherein the memory further comprises instructions for altering the first data model.

4. The system of claim 3, wherein altering the first data model occurs in response to receiving an indication from the user device of a requested alteration to the first data model.

5. The system of claim 3, wherein altering the first data model includes:
determining, by the first computer system, a suggested alteration to the first data model;
transmitting, for display by the user device, information corresponding to the suggested alteration to the first data model; and
receiving an indication from the user device of a verification of the suggested alteration to the first data model.

6. The system of claim 5, wherein the information corresponding to the suggested alteration of the first data model includes at least a portion of the first data model.

7. The system of claim 5, wherein the information corresponding to the suggested alteration of the first data model includes at least a portion of the data subset of the first set of one or more databases.

8. The system of claim 3, wherein altering the first data model includes adding one or more relations between domains of the first data model.

9. The system of claim 3, wherein altering the first data model includes modifying one or more identifiers associated with a respective entity of the first data model.

10. The system of claim 9, wherein modifying one or more identifiers of the respective entity of the first data model includes substituting a synonym of an identifier associated with the respective entity of the first data model for the identifier associated with the respective entity of the first data model.

11. The system of claim 10, wherein the synonym is selected from a list of synonyms for the one or more identifiers associated with the respective entity of the first data model.

12. The system of claim 3, wherein generating the training set for training the first agent includes generating one or more sample requests based on the altered first data model.

13. The system of claim 1, wherein the first data model is retrieved in accordance with a defined scope of access to the one or more databases.

14. The system of claim 1, wherein generating the training set for training the first agent includes generating at least one sample request of the plurality of sample requests by replacing a keyword in a template request with a respective value from a set of values of the data subset of the first set of one or more databases.

15. The system of claim 1, where the training set for training the first agent includes at least one sample request that is generated based on one or more queries received from the user device.

16. The system of claim 1, wherein generating the training set for training the first agent includes:
accessing a query log of the user device;
analyzing at least one query of the query log; and
generating at least one sample request of the plurality of sample requests based on analyzing the at least one query of the query log.

17. The system of claim 16, wherein generating the plurality of sample requests includes replacing a keyword in a type of query of the query log.

18. The system of claim 1, wherein the memory further comprises instructions for:
retrieving a second data model comprising a second set of one or more entities, wherein a respective entity of the second set of one or more entities relates to a data subset of a second set of one or more databases;
generating, based on the second data model, a training set for training a second agent;
receiving a first user input query; and
determining, using agent selection criteria, a respective agent of a plurality of agents including the first agent and the second agent for providing a response to the first user input query.

19. The system of claim 1, wherein training the agent includes incorporating feedback provided by one or more users of the second computer system.

20. The system of claim 1, wherein training the agent includes utilizing a named-entity recognition extraction.

21. A method comprising:
at a first computer system:
retrieving a first data model comprising a first set of one or more entities, wherein a respective entity of the first set of one or more entities:
relates to a data subset of a first set of one or more databases, and
corresponds to at least one of a metric, a dimension, or a filter; and
generating, based on the first data model, a training set for training a first agent, the first agent being configured to respond to user input queries formulated in natural language, the training set for training the first agent including:
a plurality of sample requests, and
a plurality of database queries for the one or more databases, wherein at least one respective database query of the plurality of database queries corresponds to at least one respective sample request of the plurality of sample requests.

22. A non-transitory computer readable storage medium storing one or more programs for execution by one or more processors of a computer system, the one or more programs comprising instructions for:
retrieving a first data model comprising a first set of one or more entities, wherein a respective entity of the first set of one or more entities:
relates to a data subset of a first set of one or more databases, and
corresponds to at least one of a metric, a dimension, or a filter; and
generating, based on the first data model, a training set for training a first agent, the first agent being configured to respond to user input queries formulated in natural language, the training set for training the first agent including:
a plurality of sample requests, and
a plurality of database queries for the one or more databases, wherein at least one respective database query of the plurality of database queries corresponds to at least one respective sample request of the plurality of sample requests.
